(19) United States
(12) Patent Application Publication
(10) Pub. No.: US 2023/0168614 A1
(43) Pub. Date: Jun. 1, 2023

(54) IMAGE FORMING APPARATUS

(71) Applicant: KYOCERA Document Solutions Inc., Osaka (JP)

(72) Inventors: Shunsaku FUJII, Osaka (JP); Takashi EIKI, Osaka (JP); Ryohei TOKUNAGA, Osaka (JP); Yuta KITABAYASHI, Osaka (JP); Rina KIKUGAWA, Osaka (JP); Hiroki KAWASAKI, Osaka (JP); Tei TO, Osaka (JP)

(73) Assignee: KYOCERA Document Solutions Inc., Osaka (JP)

(21) Appl. No.: 18/059,220

(22) Filed: Nov. 28, 2022

(30) Foreign Application Priority Data
Nov. 29, 2021 (JP) 2021-193610

(51) Int. Cl. G03G 15/20

(52) U.S. Cl. CPC G03G 15/2053; G03G 15/2028; G03G 15/2039

(57) ABSTRACT

An image forming apparatus includes a fixing belt, a pressing member, a heating source, a temperature detecting element, a recording medium detection unit, and a control unit. The heating source is arranged to be opposed to the pressing member via the fixing belt so as to be in contact with an inner circumferential surface of the fixing belt and heats the fixing belt at a fixing nip between the fixing belt and the pressing member. The temperature detecting element detects a temperature of the heating source. The recording medium detection unit is arranged, on a conveyance path, on an upstream side of the fixing nip in a conveyance direction of a recording medium and detects presence/absence of the recording medium being conveyed. Based on the presence/absence of the recording medium detected by the recording medium detection unit, the control unit controls timing for energizing the heating source.

### INCORPORATION BY REFERENCE

This application is based upon and claims the benefit of priority from the corresponding Japanese Patent Application No. 2021-193610 filed on Nov. 29, 2021, the entire contents of which are incorporated herein by reference.

### BACKGROUND

The present disclosure relates to an image forming apparatus.

Image forming apparatuses employing an electrophotographic method such as a copy machine and a printer widely adopt a heat fixing method as a method for fixing, on a sheet, an unfixed toner image that has been transferred on a recording medium such as the sheet. The sheet passes through a fixing nip at which a fixing member and a pressing member are in contact with each other, and thus the unfixed toner image thereon is pressed and heated to be fixed. There is further known a method in which an endless fixing belt is used as the fixing member.

### SUMMARY

An image forming apparatus according to an aspect of the present disclosure includes a fixing belt, a pressing member, a heating source, a temperature detecting element, a recording medium detection unit, and a control unit. The fixing belt is endless and is rotatable along a conveyance direction of a recording medium. The pressing member is in contact with an outer circumferential surface of the fixing belt. The heating source is arranged to be opposed to the pressing member via the fixing belt so as to be in contact with an inner circumferential surface of the fixing belt and heats the fixing belt at a fixing nip between the fixing belt and the pressing member. The temperature detecting element detects a temperature of the heating source. The recording medium detection unit is arranged, on a conveyance path, on an upstream side of the fixing nip in the recording medium conveyance direction and detects presence/absence of the recording medium being conveyed. The control unit controls operations of the fixing belt and the heating source. Based on the presence/absence of the recording medium detected by the recording medium detection unit, the control unit controls timing for energizing the heating source.

### BRIEF DESCRIPTION OF THE DRAWINGS

FIG. 1 is a schematic sectional front view of an image forming apparatus according to an embodiment of the present disclosure.

FIG. 2 is a block diagram showing a configuration of the image forming apparatus shown in FIG. 1.

FIG. 3 is a sectional front view of a fixing device in the image forming apparatus shown in FIG. 1.

FIG. 4 is a graph showing a temperature transition of a fixing belt in an image forming apparatus of a comparative example.

FIG. 5 is a graph showing a temperature transition of a fixing belt in an image forming apparatus of an example.

### DETAILED DESCRIPTION

Based on the appended drawings, the following describes an embodiment of the present disclosure. The present disclosure, however, is not limited to the following descriptions.

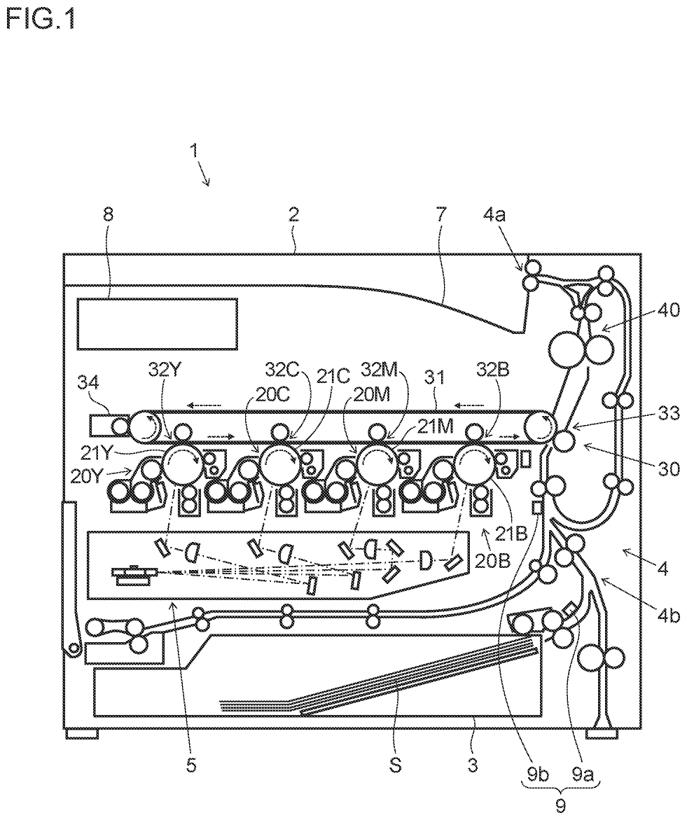

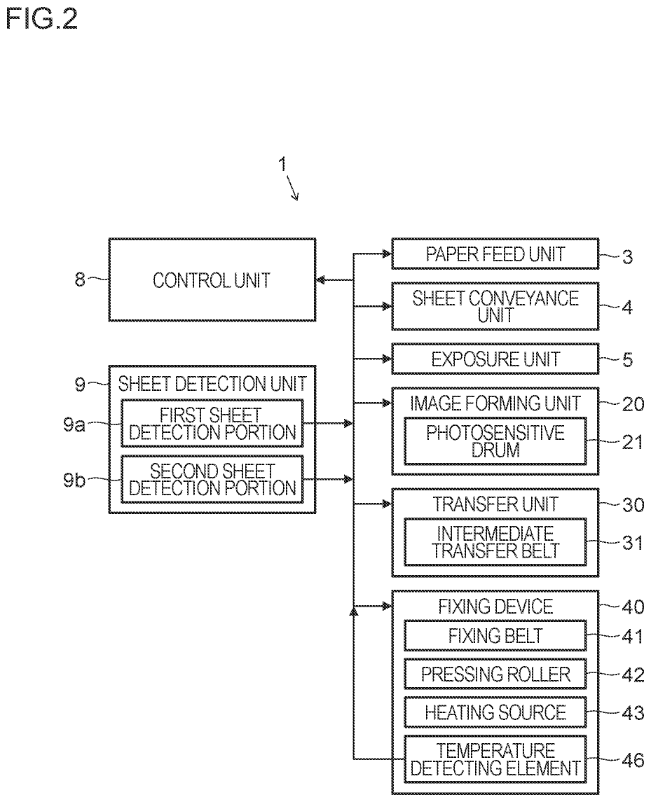

FIG. 1 is a schematic sectional front view of an image forming apparatus 1 according to the embodiment. FIG. 2 is a block diagram showing a configuration of the image forming apparatus 1 shown in FIG. 1. The image forming apparatus 1 according to this embodiment is exemplified by a tandem color printer that uses an intermediate transfer belt 31 to transfer a toner image on a sheet (recording medium) S. The image forming apparatus 1 may be a so-called multi-functional peripheral having functions such as, for example, printing, scanning (image reading), and facsimile transmission.

As shown in FIG. 1 and FIG. 2, the image forming apparatus 1 includes, in a main body 2 thereof, a paper feed unit (recording medium housing unit) 3, a sheet conveyance unit 4, an exposure unit 5, image forming units 20, a transfer unit 30, a fixing device 40, a sheet discharge unit 7, and a control unit 8.

The paper feed unit 3 is arranged at a bottom of the main body 2. The paper feed unit 3 houses a plurality of sheets S before being subjected to recording and feeds out the sheets S one by one separately during printing. The sheet conveyance unit 4 extends in an up-down direction along a side wall of the main body 2. The sheet conveyance unit 4 conveys the sheet S fed out of the paper feed unit 3 to a secondary transfer portion 33 and to the fixing device 40 and further discharges the sheet S after being subjected to fixing to the sheet discharge unit 7 through a sheet discharge port 4a. The exposure unit 5 is arranged above the paper feed unit 3. The exposure unit 5 applies laser light controlled based on image data toward the image forming units 20.

The image forming units 20 are arranged above the exposure unit 5 and below the intermediate transfer belt 31. The image forming units 20 include a yellow color image forming unit 20Y, a cyan color image forming unit 20C, a magenta color image forming unit 20M, and a black color image forming unit 20B. These four image forming units 20 are identical in basic configuration. In the following descriptions, symbols “Y,” “C,” “M,” and “B” for identifying the respective colors, therefore, may be omitted unless particularly required to be limited.

The image forming units 20 each include a photosensitive drum 21 that is supported so as to be rotatable in a prescribed direction (clockwise in FIG. 1). The image forming units 20 each further include, around the photosensitive drum 21, a charging portion, a developing portion, and a drum cleaning portion that are arranged along the rotation direction of the photosensitive drum 21. A primary transfer portion 32 is arranged between the developing portion and the drum cleaning portion.

The photosensitive drum 21 has a photosensitive layer provided on an outer circumferential surface thereof. The charging portion charges the outer circumferential surface of the photosensitive drum 21 to a prescribed potential. The exposure unit 5 exposes to light the outer circumferential surface of the photosensitive drum 21 charged by the charging portion so that an electrostatic latent image of an original document image is formed on the outer circumferential surface of the photosensitive drum 21. The developing portion supplies a toner to the electrostatic latent image so as to develop it into a toner image. The four image forming units 20 form toner images of different colors from each other. The drum cleaning portion performs cleaning by removing a residual toner or the like remaining on the outer circumferential surface of the photosensitive drum 21 after the toner image has been primarily transferred on an outer circumferential surface of the intermediate transfer belt 31. In this way, the image forming units 20 form images (toner images) to be transferred later on the sheet S.

The transfer unit 30 includes the intermediate transfer belt 31, primary transfer portions 32Y, 32C, 32M, and 32B, the secondary transfer portion 33, and a belt cleaning portion 34. The intermediate transfer belt 31 is arranged above the four image forming units 20. The intermediate transfer belt 31 is supported so as to be rotatable in a prescribed direction (counterclockwise in FIG. 1). The intermediate transfer belt 31 is an intermediate transfer member on which the toner images formed respectively on the outer circumferential surfaces of the photosensitive drums 21 in the four image forming units 20 are sequentially and primarily transferred in a superimposed manner. The four image forming units 20 are arranged in a so-called tandem formation in which they line up in a row from an upstream side toward a downstream side in a rotation direction of the intermediate transfer belt 31.

Each of the primary transfer portions 32Y, 32C, 32M, and 32B is arranged above a corresponding one of the image forming units 20Y, 20C, 20M, and 20B of the respective colors via the intermediate transfer belt 31. The secondary transfer portion 33 is arranged, in the sheet conveyance unit 4, on an upstream side relative to the fixing device 40 in a sheet conveyance direction and, in the transfer unit 30, on a downstream side relative to the image forming units 20Y, 20C, 20M, and 20B of the respective colors in the rotation direction of the intermediate transfer belt 31. The belt cleaning portion 34 is arranged on an upstream side relative to the image forming units 20Y, 20C, 20M, and 20B of the respective colors in the rotation direction of the intermediate transfer belt 31.

The primary transfer portions 32 transfer, on the intermediate transfer belt 31, the toner images formed respectively on the outer circumferential surfaces of the photosensitive drums 21. In other words, the toner images are primarily transferred on the outer circumferential surface of the intermediate transfer belt 31 at the primary transfer portions 32Y, 32C, 32M, and 32B of the respective colors. Further, as the intermediate transfer belt 31 rotates, at prescribed timing, the toner images formed in the four image forming units 20 are successively transferred in a superimposed manner on the intermediate transfer belt 31, and thus the toner images of the four different colors of yellow, cyan, magenta, and black are superimposed to form a color toner image on the outer circumferential surface of the intermediate transfer belt 31.

The color toner image on the outer circumferential surface of the intermediate transfer belt 31 is transferred, at a secondary transfer nip formed in the secondary transfer portion 33, on the sheet S synchronously fed thereto by the sheet conveyance unit 4. The belt cleaning portion 34 performs cleaning by removing a residual toner or the like remaining on the outer circumferential surface of the intermediate transfer belt 31 after the secondary transfer. In this way, the transfer unit 30 transfers (records), on the sheet S, toner images formed respectively on the outer circumferential surfaces of the photosensitive drums 21.

The fixing device 40 is arranged above the secondary transfer portion 33. The fixing device 40 applies heat and pressure to the sheet S on which the toner image has been transferred so that the toner image is fixed on the sheet S.

The sheet discharge unit 7 is arranged above the transfer unit 30. The sheet S on which the toner image has been fixed to complete printing thereon is conveyed to the sheet discharge unit 7. A printed sheet (printed matter) is taken out from an upper part of the sheet discharge unit 7.

The control unit 8 includes a CPU, an image processing portion, a storage portion, and other electronic circuitry and electronic components (none of which are shown). Based on control programs and data stored in the storage portion, the CPU controls operations of the constituent elements provided in the image forming apparatus 1 so as to perform processing related to functions of the image forming apparatus 1. The paper feed unit 3, the sheet conveyance unit 4, the exposure unit 5, the image forming units 20, the transfer unit 30, and the fixing device 40 individually receive commands from the control unit 8 to perform printing on the sheet S in conjunction with each other. The storage portion is formed of, for example, a combination of a non-volatile storage device such as a program ROM (read-only memory) or a data ROM and a volatile storage device such as a RAM (random-access memory).

The image forming apparatus 1 further includes a sheet detection unit (recording medium detection unit) 9 on a conveyance path 4b of the sheet conveyance unit 4. The sheet detection unit 9 is arranged, on the conveyance path 4b, on an upstream side of an after-mentioned fixing nip N in the sheet conveyance direction. The sheet detection unit 9 includes a first sheet detection portion 9a and a second sheet detection portion 9b. The sheet detection unit 9 detects presence/absence of the sheet S being conveyed. A detection signal indicating that the sheet S has been detected by the sheet detection unit 9 is transmitted to the control unit 8.

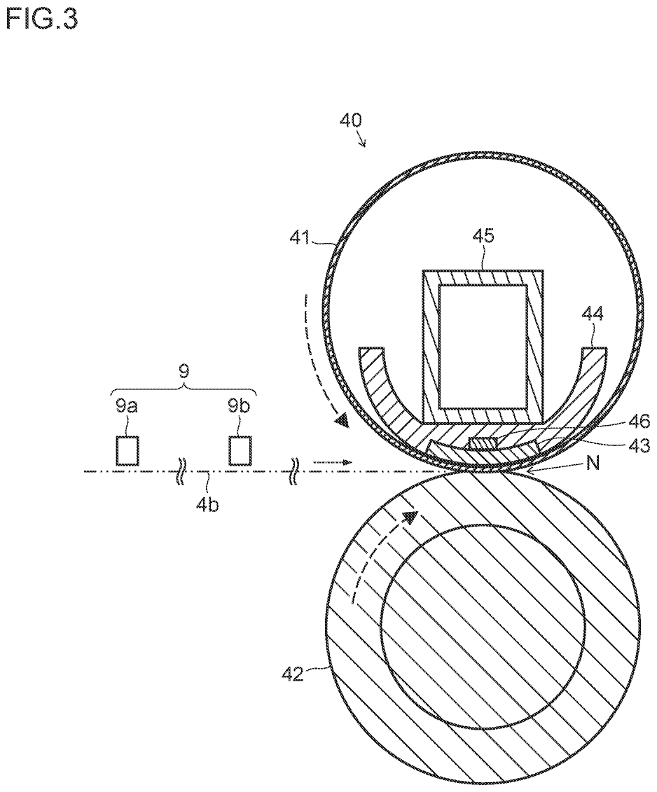

Next, a description is given of a configuration of the fixing device 40 with reference to FIG. 3. FIG. 3 is a sectional front view of the fixing device 40 in the image forming apparatus 1 shown in FIG. 1.

FIG. 3 depicts a configuration in which, for the sake of convenience of explanation, with respect to the fixing nip N, the fixing belt 41 is arranged on an upper side and a pressing roller (pressing member) 42 is arranged on a lower side. In FIG. 3, a left side corresponds to an upstream side (a side toward the transfer unit 30) with respect to the fixing device 40 in the sheet conveyance direction, and a right side corresponds to a downstream side (a side toward the sheet discharge unit 7) with respect to the fixing device 40 in the sheet conveyance direction.

FIG. 3 also depicts a positional relationship between the fixing device 40 and each of the first sheet detection portion 9a and the second sheet detection portion 9b. The first sheet detection portion 9a is arranged, for example, on a downstream side of the paper feed unit 3 in the sheet conveyance direction. The first sheet detection portion 9a detects presence/absence of the sheet S conveyed out of the paper feed unit 3. The second sheet detection portion 9b is arranged, for example, on a downstream side of the first sheet detection portion 9a and on an upstream side of the fixing nip N in the sheet conveyance direction. The second sheet detection portion 9b detects presence/absence of the sheet S being conveyed after passing through a location of the first sheet detection portion 9a. The second sheet detection portion 9b may be a sensor that is arranged, for example, on an upstream side of a registration roller pair for feeding the sheet S toward the secondary transfer nip and detects arrival of the sheet S at a location of the registration roller pair.

As shown in FIG. 3, the fixing device 40 includes the fixing belt 41, the pressing roller (pressing member) 42, a heating source 43, a heating source holding member 44, a supporting member 45, and a temperature detecting element 46.

The fixing belt 41 is supported to a housing of the fixing device 40 so as to be rotatable about a horizontal axis. The fixing belt 41 is configured in an endless cylindrical shape having an outer diameter of, for example, 20 mm to 50 mm and is substantially equal in length to the pressing roller 42 in a rotation axis direction (a width direction of the sheet S orthogonal to a conveyance direction thereof). The fixing belt 41 is rotatable along the conveyance direction of the sheet S as a recording medium.

The fixing belt 41 has a laminar structure in which an elastic layer and a mold-release layer are provided on an outer circumferential side of a heat generation layer as a base layer. The heat generation layer is formed of, for example, a metallic film of nickel or the like having a thickness of 30 μm to 50 μm or, for example, a polyimide film having a thickness of 50 μm to 100 μm into which a metal powder of copper, silver, aluminum, or the like is blended. The elastic layer is formed of, for example, a layer of silicone rubber or the like having a thickness of 100 μm to 500 μm. The mold-release layer is formed of, for example, a layer of a fluorine-based resin such as PFA (tetrafluoroethylene-perfluoroalkyl vinyl ether copolymer) having a thickness of 30 μm to 50 μm.

The pressing roller 42 is supported to the housing of the fixing device 40 so as to be rotatable about the horizontal axis. The pressing roller 42 is configured in a columnar shape and is substantially equal in length to the fixing belt 41 in the rotation axis direction (a sheet width direction). With respect to the pressing roller 42, a prescribed pressure is applied toward the fixing belt 41 by an unshown pressing mechanism. Under this pressure, the pressing roller 42 is brought into contact with an outer circumferential surface of the fixing belt 41. The fixing nip N is formed between the pressing roller 42 and the fixing belt 41.

The pressing roller 42 is connected to, for example, a drive source (not shown) including a motor and rotates clockwise in FIG. 3 by using power received from the motor. The pressing roller 42 is in contact with the outer circumferential surface of the fixing belt 41 and applies a rotation drive force to the fixing belt 41. An operation of the fixing belt 41 is controlled by the control unit 8.

The pressing roller 42 has a laminar structure in which an elastic layer and a mold-release layer are provided on an outer circumferential side of a core bar. The core bar is formed of, for example, a metal bar of aluminum or the like having a diameter of about 20 mm. The elastic layer is formed of, for example, a layer of silicone rubber or the like having a thickness of about 3 mm to 8 mm. The mold-release layer is formed of, for example, a layer of a fluorine-based resin such as PFA having a thickness of about 10 μm to 50 μm.

The heating source 43 is arranged inside the fixing belt 41 so as to be opposed to the pressing roller 42 via the fixing belt 41. The heating source 43 is in contact with an inner circumferential surface of the fixing belt 41 adjacently to the fixing nip N between the fixing belt 41 and the pressing roller 42.

The heating source 43 extends for a length substantially equal to the length of the fixing belt 41 along the rotation axis direction (the sheet width direction) of the fixing belt 41. The heating source 43 formed of, for example, a resistance heating element is in contact with the fixing belt 41 and thus directly heats the fixing belt 41 at the fixing nip N. An operation of the heating source 43 is controlled by the control unit 8.

The heating source holding member 44 is arranged inside the fixing belt 41 so as to be opposed to the pressing roller 42 via the fixing belt 41. The heating source holding member 44 extends for a length substantially equal to the length of the fixing belt 41 along the rotation axis direction (the sheet width direction) of the fixing belt 41. The heating source holding member 44 holds the heating source 43 so as to maintain a contact state between the heating source 43 and the fixing belt 41.

A sliding member may be arranged in a region in which the heating source 43 and the heating source holding member 44 are adjacent to the inner circumferential surface of the fixing belt 41. The sliding member is made of, for example, a fluorine-based resin such as PFA, and the use thereof can reduce a sliding load with respect to the inner circumferential surface of the fixing belt 41.

The supporting member 45 is positioned, inside the fixing belt 41, in a vicinity of a radial center of the fixing belt 41 and is arranged adjacently to the heating source holding member 44. The supporting member 45 extends for a length longer than the length of the fixing belt 41 along the rotation axis direction (the sheet width direction) of the fixing belt 41. The supporting member 45 supports the heating source holding member 44.

The temperature detecting element 46 is, for example, arranged to be opposed to the fixing nip N via the heating source 43. The temperature detecting element 46 is formed of, for example, a thermistor and is in contact with the heating source 43. The temperature detecting element 46 detects a temperature of the heating source 43.

Here, when the heating source holding member 44 holding the heating source 43 stores heat, a rate of temperature increase of the fixing belt 41 might be increased at a position thereon in proximity to the heating source holding member 44. This leads to a concern that, in a case where a fixing standby state is established due to, for example, a delay in conveying the sheet S, the fixing belt 41 might be overly heated to an excessively high temperature.

In no case does such an issue arise in a configuration in which a temperature of the fixing belt 41 is directly detected. This is because, in the configuration in which the temperature of the fixing belt 41 is directly detected, the temperature of the fixing belt 41 can be controlled to be constant regardless of whether conveyance of the sheet S is being performed normally or delayed.

In a case of prediction control, however, in which, as in the configuration of this embodiment, the temperature of the heating source 43 is detected by the temperature detecting element 46 and is used to predict the temperature of the fixing belt 41 based on which fixing is controlled, when the fixing standby state is established due to a delay in conveying the sheet S, the fixing belt 41 might be heated to an excessively high temperature.

As a solution to this, based on presence/absence of the sheet S being conveyed, which is detected by the sheet detection unit 9, the control unit 8 of this embodiment controls timing for energizing the heating source 43. According to this configuration, even when the fixing standby state is established due to a delay in conveying the sheet S, it is possible to suppress an excessive temperature increase of the fixing belt 41. That is, it is possible to favorably control the temperature of the fixing belt 41.

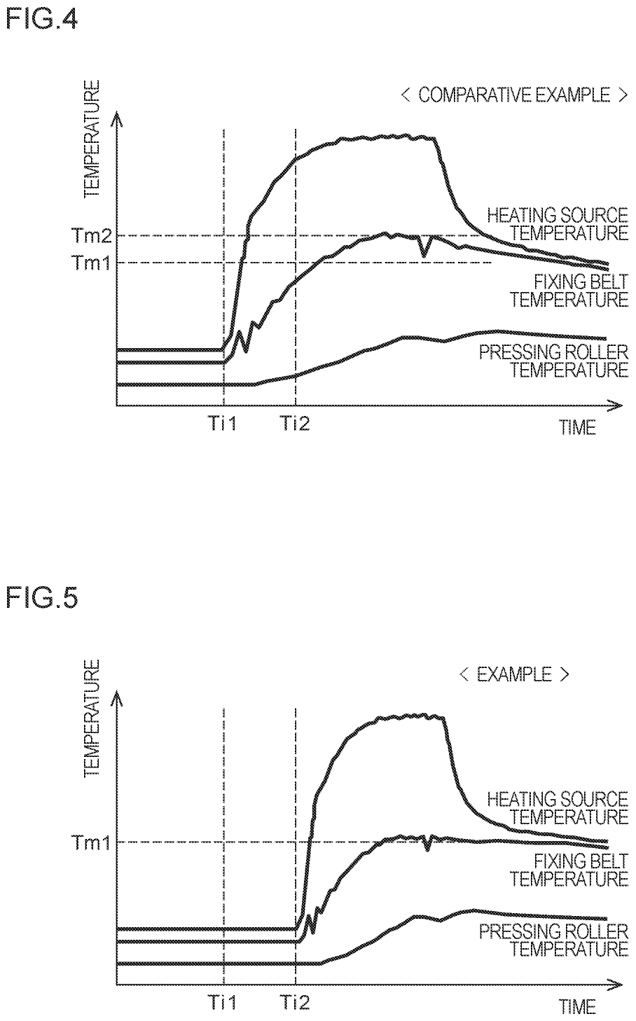

FIG. 4 is a graph showing a temperature transition of a fixing belt in an image forming apparatus of a comparative example. FIG. 5 is a graph showing a temperature transition of the fixing belt 41 in the image forming apparatus 1 of an example. FIG. 4 and FIG. 5 both show respective temperature transitions of the fixing belt 41, the pressing roller 42, and the heating source 43 when the fixing standby state is established due to a delay in conveying the sheet S.

In the image forming apparatus of the comparative example shown in FIG. 4, there is carried out no control in which, based on presence/absence of a sheet being conveyed, timing for energizing a heating source is controlled. It can, therefore, be seen that, after energization of the heating source is turned on at a time Ti1, due to a delay in sheet conveyance, a temperature of the fixing belt exceeds a target temperature Tm1 to reach as high as a temperature Tm2. That is, in the image forming apparatus of the comparative example shown in FIG. 4, a fixing standby state is established due to the delay in sheet conveyance, and thus the fixing belt is overly heated to an excessively high temperature.

In the image forming apparatus 1 of the example shown in FIG. 5, on the other hand, based on presence/absence of the sheet S being conveyed, which is detected by the sheet detection unit 9, timing for energizing the heating source 43 is controlled. To be more specific, the control unit 8 performs control so that, in a case where the second sheet detection portion 9b does not detect the sheet S after a lapse of a prescribed amount of time from detection of the sheet S by the first sheet detection portion 9a, the energization of the heating source 43 is turned off, and timing for re-energizing the heating source 43 is delayed.

That is, the control unit 8 performs control so that, in a case where there is a delay in conveying the sheet S with respect to a time Ti1 that is timing for turning on the energization of the heating source 43 in a normal state of sheet conveyance in which there is no delay in conveying the sheet S, the timing for re-energizing the heating source 43 is delayed, and the energization of the heating source 43 is turned on at a time Ti2. With this configuration, when the sheet S reaches the fixing nip N, as shown in FIG. 5, the temperature of the fixing belt 41 timely reaches a target temperature Tm1. That is, according to the image forming apparatus 1 of the example shown in FIG. 5, even when the fixing standby state is established due to a delay in conveying the sheet S, it is possible to suppress an excessive temperature increase of the fixing belt 41 and thus to favorably control the temperature of the fixing belt 41.

Moreover, based on a cumulative number of sheets S subjected to recording during a prescribed period of time before the energization of the heating source 43 is turned off, the control unit 8 changes the timing for re-energizing the heating source 43. According to this configuration, it becomes possible to favorably control the timing for re-energizing the heating source 43 in consideration of a degree to which the fixing belt 41 has been heated.

For example, when the cumulative number of sheets S subjected to recording is increased, an amount of heat stored by the fixing belt 41 is increased. Thus, the control unit 8 performs control so that the higher the cumulative number of sheets subjected to recording, the more the timing for re-energizing the heating source 43 is delayed. With this configuration, heating the fixing belt 41 for a short time makes it possible that when the sheet S reaches the fixing nip N, the temperature of the fixing belt 41 timely reaches a target temperature. That is, it is possible to suppress an excessive temperature increase of the fixing belt 41.

Furthermore, based on a cumulative amount of time taken for recording on the sheets S during a prescribed period of time before the energization of the heating source 43 is turned off, the control unit 8 changes the timing for re-energizing the heating source 43. According to this configuration, similarly to the above, it becomes possible to favorably control the timing for re-energizing the heating source 43 in consideration of a degree to which the fixing belt 41 has been heated.

For example, when the cumulative amount of time taken for recording on the sheets S is increased, an amount of heat stored by the fixing belt 41 is increased. Thus, the control unit 8 performs control so that the longer the cumulative amount of time taken for recording, the more the timing for re-energizing the heating source 43 is delayed. With this configuration, heating the fixing belt 41 for a short time makes it possible that when the sheet S reaches the fixing nip N, the temperature of the fixing belt 41 timely reaches a target temperature. That is, it is possible to suppress an excessive temperature increase of the fixing belt 41.

While the embodiment of the present disclosure has been described thus far, the present disclosure is not limited in scope thereto and can be implemented by adding various modifications thereto without departing from the spirit of the disclosure.

For example, while the foregoing embodiment uses, as the image forming apparatus 1, a color printing image forming apparatus of a so-called tandem type in which images of a plurality of different colors are sequentially formed in a superimposed manner, there is no limitation thereto. The image forming apparatus 1 may be a color printing image forming apparatus of a type other than the tandem type or a monochrome printing image forming apparatus.

What is claimed is:

1. An image forming apparatus, comprising:
a fixing belt that is endless and is rotatable along a conveyance direction of a recording medium;
a pressing member that is in contact with an outer circumferential surface of the fixing belt;
a heating source that is arranged to be opposed to the pressing member via the fixing belt so as to be in contact with an inner circumferential surface of the fixing belt and heats the fixing belt at a fixing nip between the fixing belt and the pressing member;
a temperature detecting element that detects a temperature of the heating source;
a recording medium detection unit that is arranged, on a conveyance path, on an upstream side of the fixing nip in the recording medium conveyance direction and detects presence/absence of the recording medium being conveyed; and
a control unit that controls operations of the fixing belt and the heating source,
wherein
based on the presence/absence of the recording medium detected by the recording medium detection unit, the control unit controls timing for energizing the heating source.

2. The image forming apparatus according to claim 1, further comprising:
a recording medium housing unit that houses the recording medium before being subjected to recording,
wherein the recording medium detection unit includes:
a first recording medium detection portion that is arranged on a downstream side of the recording medium housing unit in the recording medium conveyance direction and detects presence/absence of the recording medium conveyed out of the recording medium housing unit; and
a second recording medium detection portion that is arranged on a downstream side of the first recording medium detection portion and on an upstream side of the fixing nip in the recording medium conveyance direction, and
the control unit performs control so that, in a case where the second recording medium detection portion does not detect the recording medium after a lapse of a prescribed amount of time from detection of the recording medium by the first recording medium detection portion, energization of the heating source is turned off, and timing for re-energizing the heating source is delayed.

3. The image forming apparatus according to claim 2, wherein
based on a cumulative number of the recording media subjected to recording during a prescribed period of time before the energization of the heating source is turned off, the control unit changes the timing for re-energizing the heating source.

4. The image forming apparatus according to claim 3, wherein
the control unit performs control so that the higher the cumulative number of the recording media subjected to recording, the more the timing for re-energizing the heating source is delayed.

5. The image forming apparatus according to claim 2, wherein
based on a cumulative amount of time taken for recording on the recording media during a prescribed period of time before the energization of the heating source is turned off, the control unit changes the timing for re-energizing the heating source.

6. The image forming apparatus according to claim 5, wherein
the control unit performs control so that the longer the cumulative amount of time taken for recording, the more the timing for re-energizing the heating source is delayed.
